(19) United States
(12) Patent Application Publication
(10) Pub. No.: US 2013/0265341 A1
(43) Pub. Date: Oct. 10, 2013

(54) METHOD FOR ADJUSTABLE OUTPUTTING GAMMA REFERENCE VOLTAGES AND SOURCE DRIVER FOR ADJUSTABLE OUTPUTTING GAMMA REFERENCE VOLTAGES

(71) Applicants: WINTEK (CHINA) TECHNOLOGY LTD., Dongguan City (CN); WINTEK CORPORATION, Taichung City (TW)

(72) Inventors: Ching-Fu Hsu, Taichung City (TW); Ting-Yu Chang, Kaohsiung City (TW); Lo-Hsien Tsai, Taoyuan County (TW); Chen-Ho Hsu, Kaohsiung City (TW)

(73) Assignees: WINTEK CORPORATION, Taichung City (TW); Wintek (China) Technology Ltd., Dongguan City (CN)

(21) Appl. No.: 13/859,749

(22) Filed: Apr. 10, 2013

(30) Foreign Application Priority Data
Apr. 10, 2012 (TW) 101112598

(51) Int. Cl. G09G 3/18

(52) U.S. Cl. CPC G09G 3/18
USPC 345/690

(57) ABSTRACT

A method for adjustable outputting Gamma reference voltages includes generating a polarity control signal corresponding to one of plural predetermined display panel types, where a plurality of polarity control signals corresponding to the panel types of the plurality of display panels are different; generating a polarity signal corresponding to the display panel according to the polarity control signal; and generating and outputting a plurality of Gamma reference voltages according to the polarity signal. The plurality of Gamma reference voltages include a positive polarity Gamma reference voltage set and a negative polarity Gamma reference voltage set, and a voltage number of the positive polarity Gamma reference voltage set is the same as a voltage number of the negative polarity Gamma reference voltage set.

### BACKGROUND OF THE INVENTION

1. Field of the Invention

The present invention relates to a method for outputting Gamma reference voltages and a source driving circuit, and particularly to a method for adjustable outputting Gamma reference voltages and a source driving circuit.

2. Description of the Prior Art

Because liquid crystals of a liquid crystal panel can not be driven by a fixed polarity voltage long term, polarity of the liquid crystals of the liquid crystal panel needs to be continuously reversed to prevent the liquid crystals of the liquid crystal panel from being polarized. Generally speaking, inversion types of the liquid crystals of the liquid crystal panel can be divided into row inversion, column inversion, dot inversion, and frame inversion. Please refer to FIG. 1A, FIG. 1B, FIG. 1C, and FIG. 1D. FIG. 1A is a diagram illustrating the row inversion of the liquid crystals of the liquid crystal panel, FIG. 1B is a diagram illustrating the column inversion of the liquid crystals of the liquid crystal panel, FIG. 1C is a diagram illustrating the dot inversion of the liquid crystals of the liquid crystal panel, and FIG. 1D is a diagram illustrating the frame inversion of the liquid crystals of the liquid crystal panel. As shown in FIG. 1A, polarity of each row pixels of the liquid crystal panel in a frame Fn and polarity of each row pixels of the liquid crystal panel in a frame Fn+1 are opposite; as shown in FIG. 1B, polarity of each column pixels of the liquid crystal panel in a frame Fn and polarity of each column pixels of the liquid crystal panel in a frame Fn+1 are opposite; as shown in FIG. 1C, polarity of each pixel of the liquid crystal panel in a frame Fn and polarity of a correspond pixel of the liquid crystal panel in a frame Fn+1 are opposite, and polarity of each pixel of the liquid crystal panel in the frame Fn is different from polarity of adjacent pixels of the liquid crystal panel in the frame Fn; and as shown in FIG. 1D, polarity of an output signal outputted by a source driving circuit in a frame Fn and polarity of an output signal outputted by the source driving circuit in a frame Fn+1 are opposite. Because the polarity of the liquid crystals of the liquid crystal panel needs to continuously reverse, the source driving circuit for driving the liquid crystal panel needs to provide a positive polarity Gamma reference voltage set and a negative polarity Gamma reference voltage set to the liquid crystal panel. Please refer to FIG. 2. FIG. 2 is a diagram illustrating a positive polarity Gamma reference voltage set V1-V7 and a negative polarity Gamma reference voltage set V8-V14 provided by the source driving circuit. As shown in FIG. 2, differences between the positive polarity Gamma reference voltage set V1-V7 and a reference voltage VREF are gradually decreased from left to right, and differences between the negative polarity Gamma reference voltage set V8-V14 and the reference voltage VREF are also gradually decreased from left to right. In addition, a vertical axis in FIG. 2 is a voltage, and a horizontal axis in FIG. 2 is a gray level.

However, an organic light-emitting diode can be self-luminous, and not be polarized. Thus, a source driving circuit for driving the organic light-emitting diode panel does not need to provide a positive polarity Gamma reference voltage set and a negative polarity Gamma reference voltage set to the organic light-emitting diode panel.

To sum up, because a requirement of the source driving circuit for driving the organic light-emitting diode panel is different from a requirement of the source driving circuit for driving the liquid crystal panel, a panel designer and a source driving circuit designer need to design different source driving circuits to correspond to the organic light-emitting diode panel and the liquid crystal panel. Thus, not only design flexibility of the panel may be significantly decreased, but also cost of the panel can not be reduced.

### SUMMARY OF THE INVENTION

An embodiment provides a method for adjustable outputting Gamma reference voltages. The method includes generating a polarity control signal corresponding to a predetermined display panel type, wherein a plurality of polarity control signals corresponding to the panel types of the plurality of display panels are different; generating a polarity signal corresponding to the display panel according to the polarity control signal; and generating and outputting a plurality of Gamma reference voltages according to the polarity signal. The plurality of Gamma reference voltages include a positive polarity Gamma reference voltage set and a negative polarity Gamma reference voltage set, and a voltage number of the positive polarity Gamma reference voltage set is the same as a voltage number of the negative polarity Gamma reference voltage set.

Another provides a source driving circuit for adjustable outputting Gamma reference voltages. The source driving circuit includes a positive polarity Gamma reference voltage generation circuit, and a negative polarity Gamma reference voltage generation circuit, a first switch pair, and a second switch pair. The positive polarity Gamma reference voltage generation circuit is used for generating and outputting a positive polarity Gamma reference voltage set. The negative polarity Gamma reference voltage generation circuit is used for generating and outputting a negative polarity Gamma reference voltage set. The first switch pair is coupled to the positive polarity Gamma reference voltage generation circuit for outputting the positive polarity Gamma reference voltage set to a panel according to a polarity signal corresponding to a panel type of a display panel of panel types of a plurality of display panels. The second switch pair is coupled to the negative polarity Gamma reference voltage generation circuit for outputting the negative polarity Gamma reference voltage set to the panel according to the polarity signal. A plurality of polarity control signals corresponding to the panel types of the plurality of display panels are different.

The present invention provides a method for adjustable outputting Gamma reference voltages and a source driving circuit for adjustable outputting Gamma reference voltages. The method and the source driving circuit utilize a controller to generate a polarity control signal corresponding to a panel type according to the panel type of a display panel of panel types of a plurality of display panels, where a plurality of polarity control signals corresponding to the panel types of the plurality of display panels are different. Then, a timing control circuit generates a polarity signal corresponding to the display panel to the source driving circuit according to the polarity control signal. Finally, the source driving circuit generates and outputs a plurality of Gamma reference voltages to the display panel according to the polarity signal. Thus, the source driving circuit not only can drive a liquid crystal panel, but can also drive an organic light-emitting diode panel according to the method for adjustable outputting Gamma reference voltages of the present invention. Therefore, the present invention not only can increase design flexibility of the source driving circuit and the display panel, but can also effectively reduce cost of the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating the row inversion of the liquid crystals of the liquid crystal panel.

FIG. 1B is a diagram illustrating the column inversion of the liquid crystals of the liquid crystal panel.

FIG. 1C is a diagram illustrating the dot inversion of the liquid crystals of the liquid crystal panel.

FIG. 1D is a diagram illustrating the frame inversion of the liquid crystals of the liquid crystal panel.

FIG. 2 is a diagram illustrating a positive polarity Gamma reference voltage set and a negative polarity Gamma reference voltage set provided by the source driving circuit.

FIG. 3 is a diagram illustrating a display system for adjustable outputting Gamma reference voltages.

FIG. 4 is a diagram illustrating the polarity signal being a polarity signal with alternating switch of positive polarity and negative polarity when the panel type is the liquid crystal panel.

FIG. 5A is a diagram illustrating the polarity signal being a polarity signal with the positive polarity when the panel type is the organic light-emitting diode panel 308.

FIG. 5B is a diagram illustrating the polarity signal being a polarity signal with the negative polarity when the panel type is the organic light-emitting diode panel.

FIG. 6A is a diagram illustrating utilizing the negative polarity Gamma reference voltage set to derive the positive polarity Gamma reference voltages.

FIG. 6B is a diagram illustrating utilizing the positive polarity Gamma reference voltage set to derive the negative polarity Gamma reference voltages.

FIG. 7 is a diagram illustrating the source driving circuit generating and outputting the Gamma reference voltages according to the polarity signal.

FIG. 8 is a flowchart illustrating a method for adjustable outputting Gamma reference voltages according to another embodiment.

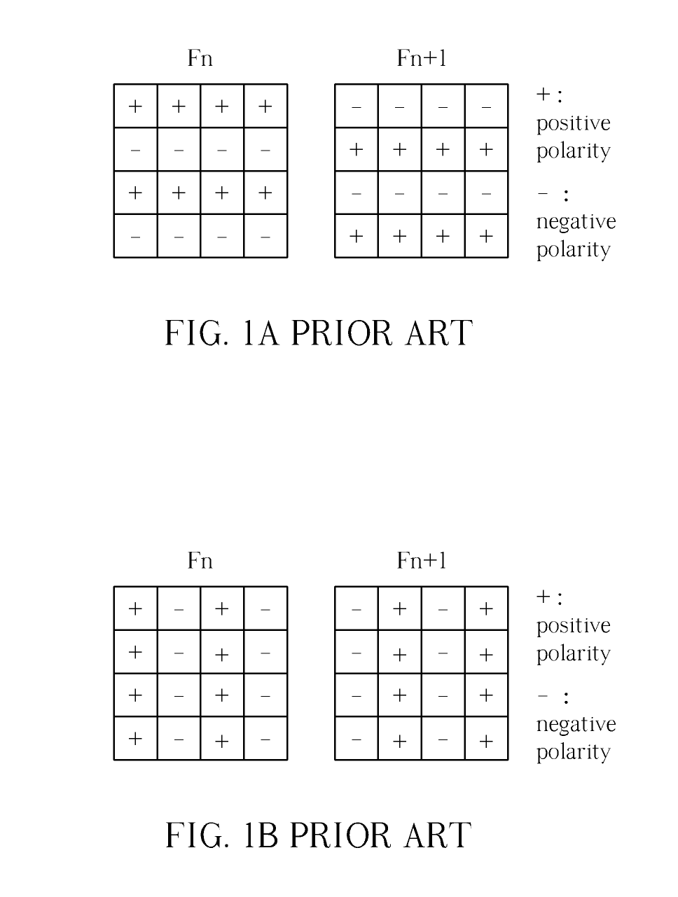

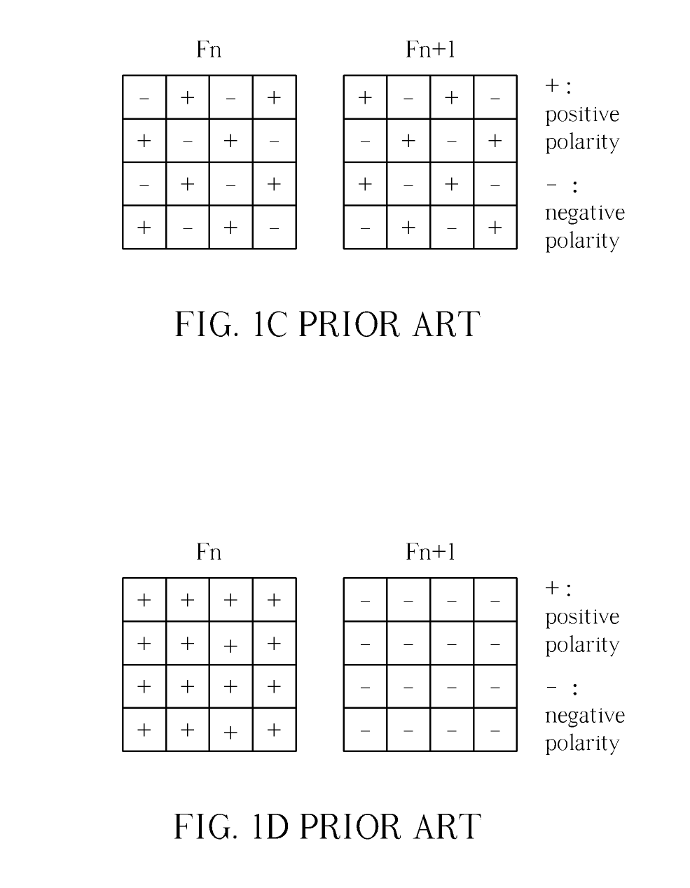

### DETAILED DESCRIPTION

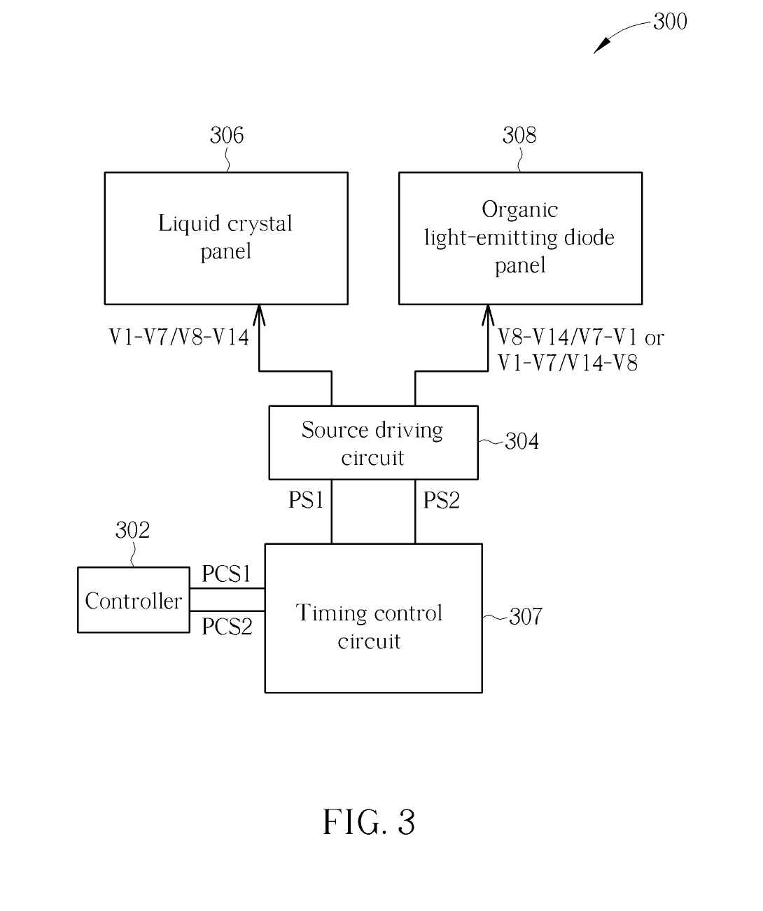

Please refer to FIG. 3. FIG. 3 is a diagram illustrating a display system 300 for adjustable outputting Gamma reference voltages. A controller 302 in the display system 300 generates a polarity control signal corresponding to a predetermined panel type. That is to say, when a source driving circuit 304 is used for driving the panel type such as a liquid crystal panel 306, the controller 302 generates a polarity control signal PCS1 corresponding to the liquid crystal panel 306 to a timing control circuit 307 according to the liquid crystal panel 306; and when the source driving circuit 304 is used for driving the panel type such as an organic light-emitting diode panel 308, the controller 302 generates a polarity control signal PCS2 corresponding to the organic light-emitting diode panel 308 to the timing control circuit 307 according to the organic light-emitting diode panel 308. Then, the timing control circuit 307 generates a polarity signal PS1 corresponding to the liquid crystal panel 306 to the source driving circuit 304 according to the polarity control signal PCS1, or the timing control circuit 307 generates a polarity signal PS2 corresponding to the organic light-emitting diode panel 308 to the source driving circuit 304 according to the polarity control signal PCS2, where the polarity control signal PCS1 is different from the polarity control signal PCS2, and the polarity signal PS1 is also different from the polarity signal PS2. As shown in FIG. 3, the timing control circuit 307 is coupled to the controller 302. Additionally, in another embodiment of the present invention, the controller 302 is included in an integrated driving circuit, where the integrated driving circuit further includes a source driving circuit, a gate driving circuit, and a timing control circuit.

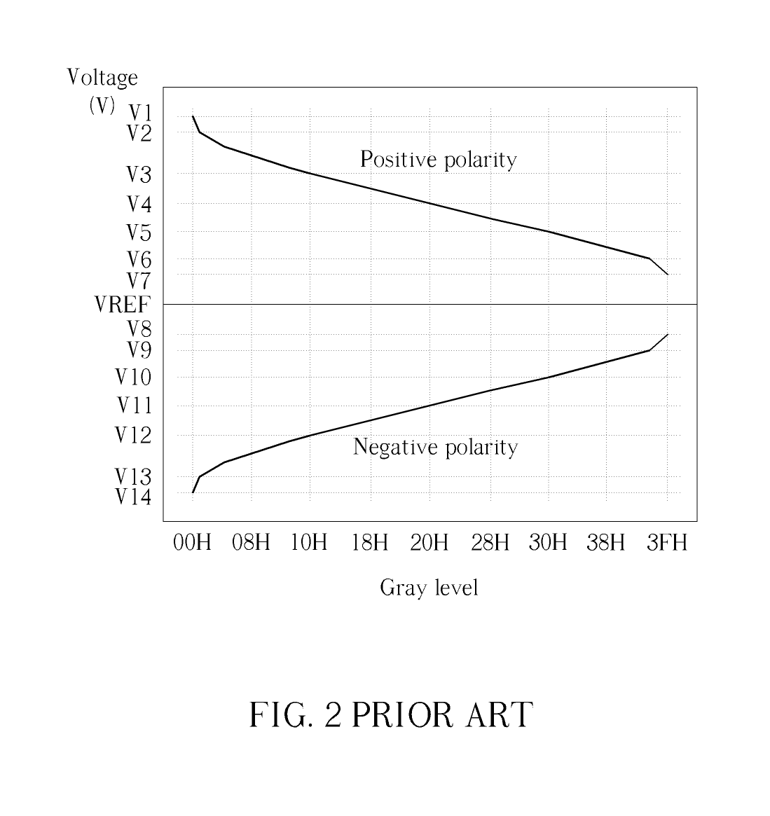

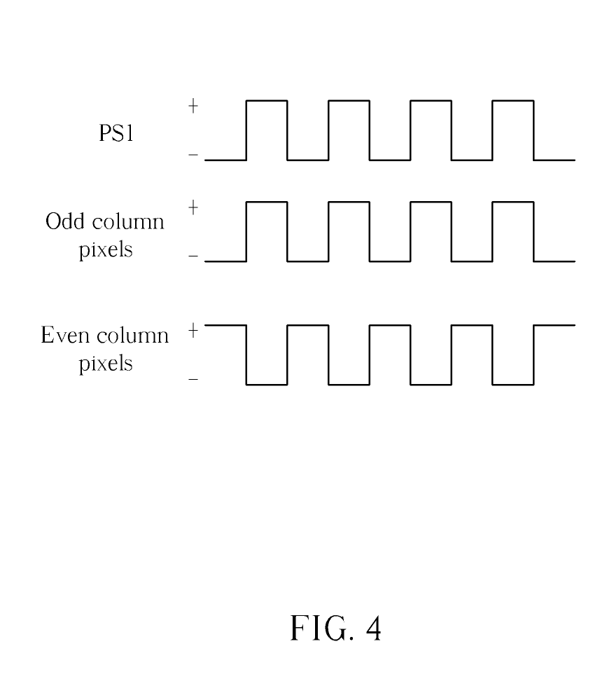

Please refer to FIG. 4. FIG. 4 is a diagram illustrating the polarity signal PS1 being a polarity signal with alternating switch of positive polarity (+) and negative polarity (−) when the panel type is the liquid crystal panel 306, where FIG. 4 only utilizes liquid crystal column inversion of the liquid crystal panel 306 to describe the present invention. Thus, as shown in FIG. 3, the source driving circuit 304 can generate and output a positive polarity Gamma reference voltage set V1-V7 and a negative polarity Gamma reference voltage set V8-V14 (as shown in FIG. 2) to the liquid crystal panel 306 in turn according to the polarity signal PS1. It is noted that each gray level corresponds to each Gamma reference voltage of the positive polarity Gamma reference voltages V1-V7 and the negative polarity Gamma reference voltages V8-V14 (as shown in FIG. 2). But, the present invention is not limited to the positive polarity Gamma reference voltage set having seven voltages V1-V7, and the negative polarity Gamma reference voltage set having seven voltages V8-V14. As shown in FIG. 4, when the polarity signal PS1 has the positive polarity (+), the source driving circuit 304 generates and outputs the positive polarity Gamma reference voltage set V1-V7 to odd column pixels of the liquid crystal panel 306, and generates and outputs the negative polarity Gamma reference voltage set V8-V14 to even column pixels of the liquid crystal panel 306 according to the polarity signal PS1 because the odd column pixels of the liquid crystal panel 306 has the positive polarity (+) and even column pixels of the liquid crystal panel 306 has the negative polarity; when the polarity signal PS1 has the negative polarity (−), the source driving circuit 304 generates and outputs the negative polarity Gamma reference voltage set V8-V14 to the odd column pixels of the liquid crystal panel 306, and generates and outputs the positive polarity Gamma reference voltage set V1-V7 to the even column pixels of the liquid crystal panel 306 according to the polarity signal PS1 because the odd column pixels of the liquid crystal panel 306 has the negative polarity (−) and the even column pixels of the liquid crystal panel 306 has the positive polarity (+). However, after the present invention is undergone simple circuit adjustment by those skilled in the technology, the source driving circuit 304 can also generate and output the positive the polarity Gamma reference voltage set V1-V7 to the even column pixels of the liquid crystal panel 306, and generate and output the negative polarity Gamma reference voltage set V8-V14 to the odd column pixels of the liquid crystal panel 306 according to the polarity signal PS1 when the polarity signal PS1 has the positive polarity (+); and the source driving circuit 304 can also generate and output the negative polarity Gamma reference voltage set V8-V14 to the even column pixels of the liquid crystal panel 306, and generate and output the positive polarity Gamma reference voltage set V1-V7 to the odd column pixels of the liquid crystal panel 306 according to the polarity signal PS1 when the polarity signal PS1 has the negative polarity (−). Alternatively, liquid crystal operations for row inversion, dot inversion, and frame inversion of the liquid crystal panel 306 are the same as those of the liquid crystal column inversion, so further description thereof is omitted for simplicity.

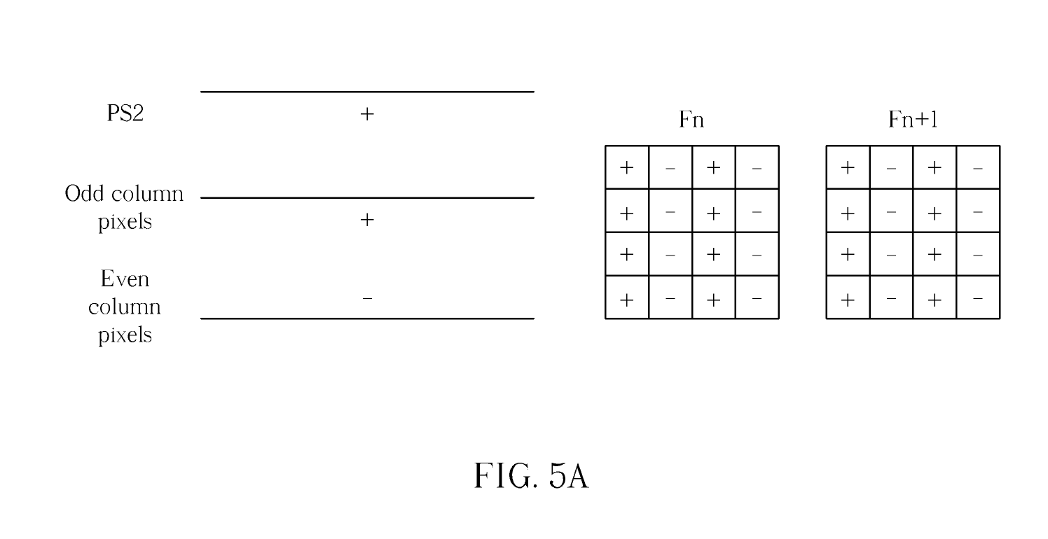

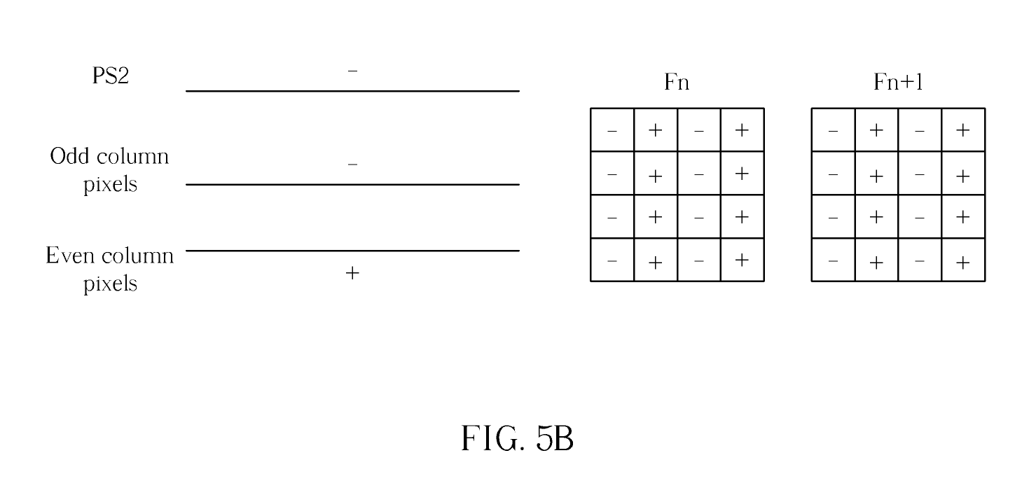

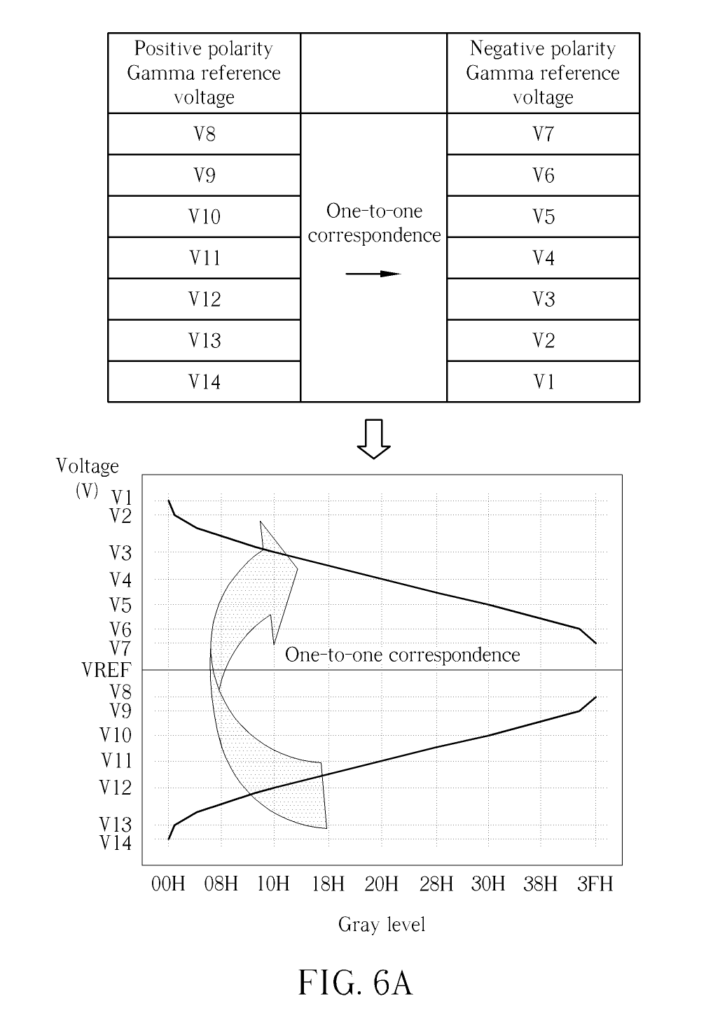

Please refer to FIG. 5A and FIG. 5B. FIG. 5A is a diagram illustrating the polarity signal PS2 being a polarity signal with the positive polarity (+) when the panel type is the organic light-emitting diode panel 308, and FIG. 5B is a diagram illustrating the polarity signal PS2 being a polarity signal with the negative polarity (−) when the panel type is the organic light-emitting diode panel 308. As shown in FIG. 3 and FIG. 5A, the source driving circuit 304 can generate and output the positive polarity Gamma reference voltage set V1-V7 to odd column pixels of the organic light-emitting diode panel 308, and generate and output a positive polarity Gamma reference voltages V7-V1 converted from the negative polarity Gamma reference voltage set V8-V14 to even column pixels of the organic light-emitting diode panel 308 according to the polarity signal PS2 (the polarity signal with the positive polarity (+)); or as shown in FIG. 3 and FIG. 5B, the source driving circuit 304 can generate and output a negative polarity Gamma reference voltage set V14-V8 converted from the positive polarity Gamma reference voltage set V1-V7 to the even column pixels of the organic light-emitting diode panel 308, and generate and output the negative polarity Gamma reference voltage set V8-V14 to the odd column pixels of the organic light-emitting diode panel 308 according to the polarity signal PS2 (the polarity signal with the negative polarity (−)). But, the present invention is not limited to FIG. 5A and FIG. 5B being the column inversion. However, after the present invention is undergone simple circuit adjustment by those skilled in the technology, the source driving circuit 304 can also generate and output the positive polarity Gamma reference voltage set V1-V7 to the even column pixels of the organic light-emitting diode panel 308 and can also generate and output the positive polarity Gamma reference voltages V7-V1 converted from the negative polarity Gamma reference voltage set V8-V14 to the odd column pixels of the organic light-emitting diode panel 308 according to the polarity signal PS2 (the polarity signal with the positive polarity (+)) when the polarity signal PS2 has the positive polarity (+); and the source driving circuit 304 can also generate and output the negative polarity Gamma reference voltage set V14-V8 converted from the positive polarity Gamma reference voltage set V1-V7 to the odd column pixels of the organic light-emitting diode panel 308, and generate and output the negative polarity Gamma reference voltage set V8-V14 to the even column pixels of the organic light-emitting diode panel 308 according to polarity signal PS2 (the polarity signal with the negative polarity (−)) when the polarity signal PS2 has the negative polarity (−).

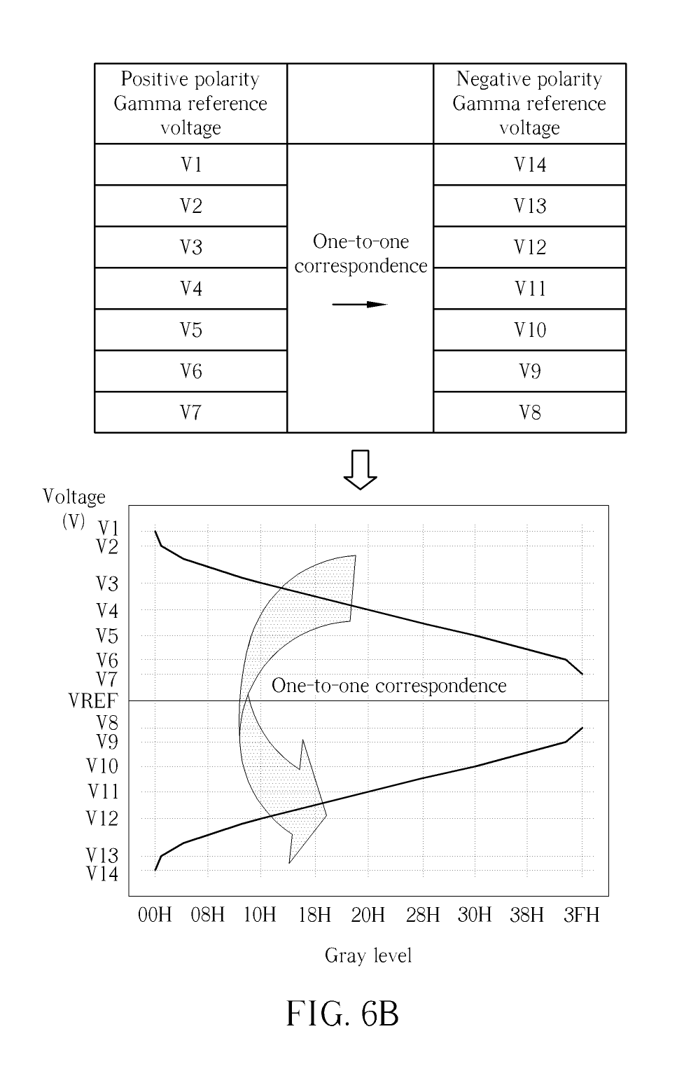

Please refer to FIG. 6A and FIG. 6B. FIG. 6A is a schematic diagram for generating the positive polarity Gamma reference voltages V7-V1 converted from the negative polarity Gamma reference voltage set V8-V14, and FIG. 6B is a schematic diagram for generating the negative polarity Gamma reference voltages V14-V8 converted from the positive polarity Gamma reference voltage set V1-V7. As shown in FIG. 6A and FIG. 2, a difference between each negative polarity Gamma reference voltage of the negative polarity Gamma reference voltage set V8-V14 and a reference voltage VREF is utilized to correspond to a difference between one positive polarity Gamma reference voltage and the reference voltage VREF to convert the positive polarity Gamma reference voltage set V7-V1. For example, a difference between the negative polarity Gamma reference voltage V14 and the reference voltage VREF is utilized to correspond to a difference between the positive polarity Gamma reference voltage V1 and the reference voltage VREF. Therefore, as shown in FIG. 6A and FIG. 5A, when the source driving circuit 304 generates and outputs the positive polarity Gamma reference voltage set V7-V1 converted from the negative polarity Gamma reference voltage set V8-V14 to the even column pixels of the organic light-emitting diode panel 308 according to the polarity signal PS2 (the polarity signal with the positive polarity (+)), the source driving circuit 304 generates and outputs the positive polarity Gamma reference voltage set V7-V1 to the even column pixels of the organic light-emitting diode panel 308 according to FIG. 6A.

As shown in FIG. 6B, a difference between each positive polarity Gamma reference voltage of the positive polarity Gamma reference voltage set V1-V7 and the reference voltage VREF is utilized to correspond to a difference between one negative polarity Gamma reference voltage and the reference voltage VREF to convert the negative polarity Gamma reference voltage set V14-V8. For example, a difference between the positive polarity Gamma reference voltage V1 and the reference voltage VREF is utilized to correspond to a difference between the negative polarity Gamma reference voltage V14 and the reference voltage VREF. Therefore, as shown in FIG. 6B and FIG. 5B, when the source driving circuit 304 generates and outputs the negative polarity Gamma reference voltage set V14-V8 converted from the positive polarity Gamma reference voltage set V1-V7 to the even column pixels of the organic light-emitting diode panel 308 according to the polarity signal PS2 (the polarity signal with the negative polarity (−)), the source driving circuit 304 generates and outputs the negative polarity Gamma reference voltage set V14-V8 to the even column pixels of the organic light-emitting diode panel 308 according to FIG. 6B.

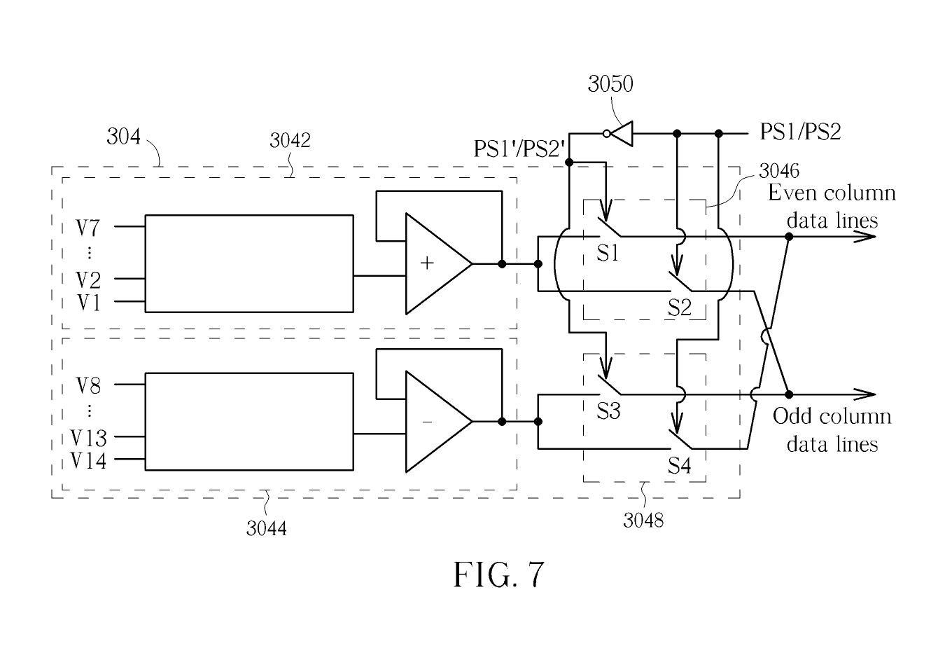

Please refer to FIG. 7. FIG. 7 is a diagram illustrating the source driving circuit 304 generating and outputting the Gamma reference voltages according to the polarity signal. As shown in FIG. 7, the source driving circuit 304 includes a positive polarity Gamma reference voltage generation circuit 3042, a negative polarity Gamma reference voltage generation circuit 3044, a first switch pair 3046, and a second switch pair 3048, where an inverter 3050 is used for reversing the polarity signals PS1/PS2 to generate inverse polarity signals PS1′/PS2′. The positive polarity Gamma reference voltage generation circuit 3042 is used for generating and outputting the positive polarity Gamma reference voltage set V1-V7; the negative polarity Gamma reference voltage generation circuit 3044 is used for generating and outputting the negative polarity Gamma reference voltage set V14-V8. The first switch pair 3046 is coupled to the positive polarity Gamma reference voltage generation circuit 3042, and includes switches S1 and S2. The switch S1 has a first terminal coupled to the positive polarity Gamma reference voltage generation circuit 3042, a second terminal for receiving the inverse polarity signals PS1′/PS2′, and a third terminal for outputting the positive polarity Gamma reference voltage set V1-V7 to the even column data lines of the liquid crystal panel 306 and the organic light-emitting diode panel 308 according to the inverse polarity signals PS1′/PS2′; the switch S2 has a first terminal coupled to the positive polarity Gamma reference voltage generation circuit 3042, a second terminal for receiving the polarity signals PS1/PS2, and a third terminal for outputting the positive polarity Gamma reference voltage set V1-V7 to the odd column data lines of the liquid crystal panel 306 and the organic light-emitting diode panel 308 according to the polarity signal PS1/PS2. The second switch pair 3048 is coupled to the negative polarity Gamma reference voltage generation circuit 3044, and includes switches S3 and S4. The switch S3 has a first terminal coupled to the negative polarity Gamma reference voltage generation circuit 3044, a second terminal for receiving the inverse polarity signals PS1′/PS2′, and a third terminal for outputting the negative polarity Gamma reference voltage set V14-V8 to the odd column data lines of the liquid crystal panel 306 and the organic light-emitting diode panel 308 according to the inverse polarity signals PS1′/PS2′; the switch S4 has a first terminal coupled to the negative polarity Gamma reference voltage generation circuit 3044, a second terminal for receiving the polarity signal PS1/PS2, and a third terminal for outputting the negative polarity Gamma reference voltage set V14-V8 to the even column data lines of the liquid crystal panel 306 and the organic light-emitting diode panel 308 according to the polarity signal PS1/PS2.

As shown in FIG. 7 and FIG. 4, when the panel type is the liquid crystal panel 306, the polarity signal PS1 is the polarity signal with alternating switch of the positive polarity (+) and the negative polarity (−). When the polarity signal PS1 has the positive polarity (+), the switches S1 and S3 are turned off, and the switches S2 and S4 are turned on. Meanwhile, the positive polarity Gamma reference voltage generation circuit 3042 of the source driving circuit 304 transmits the positive polarity Gamma reference voltages V1-V7 to the odd column pixels of the liquid crystal panel 306 through the turned-on switch S2, and the negative polarity Gamma reference voltage generation circuit 3044 of the source driving circuit 304 transmits the negative polarity Gamma reference voltages V8-V14 to the even column pixels of the liquid crystal panel 306 through the turned-on switch S4. As shown in FIG. 7 and FIG. 4, when the polarity signal PS1 has the negative polarity (−), the switches S1 and S3 are turned on, and the switches S2 and S4 are turned off. Meanwhile, the positive polarity Gamma reference voltage generation circuit 3042 of the source driving circuit 304 transmits the positive polarity Gamma reference voltages V1-V7 to the even column pixels of the liquid crystal panel 306 through the turned-on switch S1, and the negative polarity Gamma reference voltage generation circuit 3044 of the source driving circuit 304 transmits the negative polarity Gamma reference voltages V8-V14 to the odd column pixels of the liquid crystal panel 306 through the turned-on switch S3.

As shown in FIG. 7 and FIG. 5A, when the panel type is the organic light-emitting diode panel 308 and the polarity signal PS2 is the polarity signal with the positive polarity (+), the switch S1 and S3 are turned off, and the switches S2 and S4 are turned on. Meanwhile, the positive polarity Gamma reference voltage generation circuit 3042 of the source driving circuit 304 transmits the positive polarity Gamma reference voltages V1-V7 to the odd column pixels of the organic light-emitting diode panel 308 through the turned-on switch S2, and the negative polarity Gamma reference voltage generation circuit 3044 of the source driving circuit 304 transmits the positive polarity Gamma reference voltages V7-V1 converted from the negative polarity Gamma reference voltage set V8-V14 to the even column pixels of the organic light-emitting diode panel 308 through the turned-on switch S4.

As shown in FIG. 7 and FIG. 5B, when the panel type is the organic light-emitting diode panel 308 and the polarity signal PS2 is the polarity signal with the negative polarity (−), the switch S1 and S3 are turned on, and the switches S2 and S4 are turned off. Meanwhile, the positive polarity Gamma reference voltage generation circuit 3042 of the source driving circuit 304 transmits the negative polarity Gamma reference voltage set V14-V8 converted from the positive polarity Gamma reference voltage set V1-V7 to the even column pixels of the organic light-emitting diode panel 308 through the turned-on switch S1, and the negative polarity Gamma reference voltage generation circuit 3044 of the source driving circuit 304 transmits the negative polarity Gamma reference voltage set V8-V14 to the odd column pixels of the organic light-emitting diode panel 308 through the turned-on switch S3.

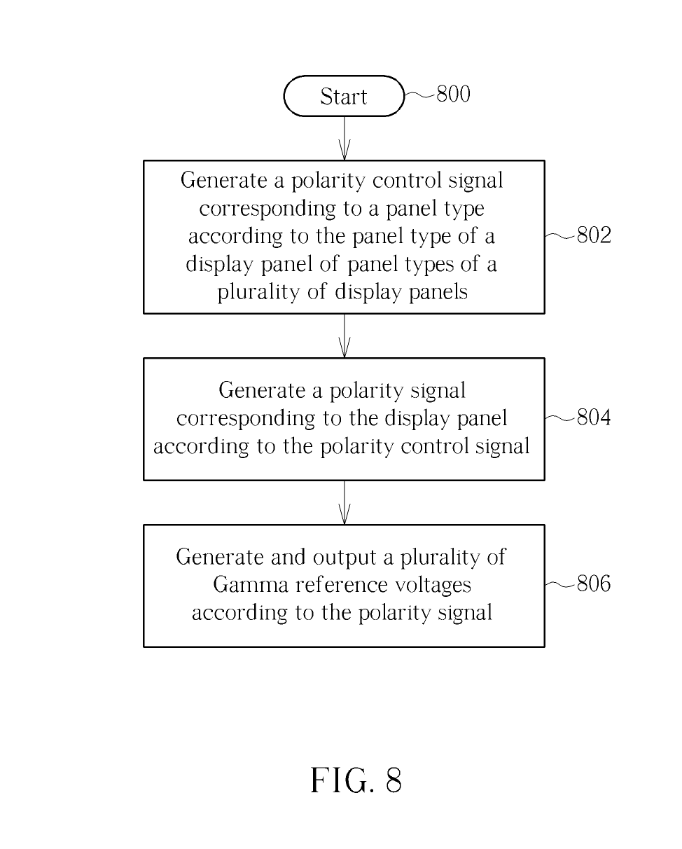

Please refer to FIG. 8, FIG. 4, FIG. 5A, and FIG. 5B. FIG. 8 is a flowchart illustrating a method for adjustable outputting Gamma reference voltages according to another embodiment. The method in FIG. 8 is illustrated using the display system 300 in FIG. 3. Detailed steps are as follows:

Step 800: Start.

Step 802: Generate a plurality of polarity control signals corresponding to one of plural predetermined display panel types.

Step 804: Generate a polarity signal corresponding to the display panel according to the polarity control signal.

Step 806: Generate and output a plurality of Gamma reference voltages according to the polarity signal.

Taking the liquid crystal panel 306 in FIG. 4 as an example:

In Step 802, the controller 302 generates the polarity control signal PCS1 corresponding to the liquid crystal panel 306 to the timing control circuit 307 according to the liquid crystal panel 306. In Step 804, the timing control circuit 307 generates the polarity signal PS1 corresponding to the liquid crystal panel 306 to the source driving circuit 304 according to the polarity control signal PCS1. In Step 806, as shown in FIG. 4, when the polarity signal PS1 has the positive polarity (+), the source driving circuit 304 generates and outputs the positive polarity Gamma reference voltage set V1-V7 to the odd column pixels of the liquid crystal panel 306, and generates and outputs the negative polarity Gamma reference voltage set V8-V14 to the even column pixels of the liquid crystal panel 306 according to the polarity signal PS1 because the odd column pixels of the liquid crystal panel 306 have the positive polarity (+) and the even column pixels of the liquid crystal panel 306 have the negative polarity (−); when the polarity signal PS1 has the negative polarity (−), the source driving circuit 304 generates and outputs the negative polarity Gamma reference voltage set V8-V14 to the odd column pixels of the liquid crystal panel 306, and generates and outputs the positive polarity Gamma reference voltage set V1-V7 to the even column pixels of the liquid crystal panel 306 according to the polarity signal PS1 because the odd column pixels of the liquid crystal panel 306 has the negative polarity (−) and the even column pixels of the liquid crystal panel 306 has the positive polarity (+).

Taking the organic light-emitting diode panel 308 in FIG. 5A as an example:

In Step 802, the controller 302 generates the polarity control signal PCS2 (different from the polarity control signal PCS1) corresponding to the organic light-emitting diode panel 308 to the timing control circuit 307 according to the organic light-emitting diode panel 308. In Step 804, the timing control circuit 307 generates the polarity signal PS2 (the polarity signal with the positive polarity (+)) corresponding to the organic light-emitting diode panel 308 to the source driving circuit 304 according to the polarity control signal PCS2. In Step 806, the source driving circuit 304 generates and outputs the positive polarity Gamma reference voltage set V1-V7 to the odd column pixels of the organic light-emitting diode panel 308, and generates and outputs the positive polarity Gamma reference voltages V7-V1 converted from the negative polarity Gamma reference voltage set V8-V14 to the even column pixels of the organic light-emitting diode panel 308 according to the polarity signal PS2 with the positive polarity (+).

Taking the organic light-emitting diode panel 308 in FIG. 5B as an example:

In Step 802, the controller 302 generates the polarity control signal PCS2 corresponding to the organic light-emitting diode panel 308 to the timing control circuit 307 according to the organic light-emitting diode panel 308. In Step 804, the timing control circuit 307 generates the polarity signal PS2 (the polarity signal with the negative polarity (−)) corresponding to organic light-emitting diode panel 308 to the source driving circuit 304 according to the polarity control signal PCS2. In Step 806, the source driving circuit 304 generates and outputs the negative polarity Gamma reference voltage set V8-V14 to the odd column pixels of the organic light-emitting diode panel 308, and generates and outputs the negative polarity Gamma reference voltage set V14-V8 converted from the positive polarity Gamma reference voltage set V1-V7 to the even column pixels of the organic light-emitting diode panel 308 according to the polarity signal PS2 with the negative polarity (−).

To sum up, the method for adjustable outputting Gamma reference voltages and the source driving circuit for adjustable outputting Gamma reference voltages utilize the controller to generate a polarity control signal corresponding to one of plural predetermined display panel types, where a plurality of polarity control signals corresponding to the panel types of the plurality of display panels are different. Then, the timing control circuit generates a polarity signal corresponding to the display panel to the source driving circuit according to the polarity control signal. Finally, the source driving circuit generates and outputs a plurality of Gamma reference voltages to the display panel according to the polarity signal. Thus, the source driving circuit not only can drive the liquid crystal panel, but can also drive the organic light-emitting diode panel according to the method for adjustable outputting Gamma reference voltages of the present invention. Therefore, the present invention not only can increase design flexibility of the source driving circuit and the display panel, but can also effectively reduce cost of the display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjustable outputting Gamma reference voltages, the method comprising:
generating a polarity control signal corresponding to one of plural predetermined display panel types, wherein a plurality of polarity control signals corresponding to the plural display panel types are different;
generating a polarity signal corresponding to the display panel according to the polarity control signal; and
generating and outputting a plurality of Gamma reference voltages according to the polarity signal.

2. The method of claim 1, wherein when the panel type is a liquid crystal panel, the polarity signal is a polarity signal with alternating switch of positive polarity and negative polarity, the plurality of Gamma reference voltages include a positive polarity Gamma reference voltage set and a negative polarity Gamma reference voltage set, and a voltage number of the positive polarity Gamma reference voltage set is the same as a voltage number of the negative polarity Gamma reference voltage set.

3. The method of claim 2, wherein when the polarity signal has the positive polarity, a source driving circuit generates and outputs the positive polarity Gamma reference voltage set to pixels of odd columns of the liquid crystal panel, and generates and outputs the negative polarity Gamma reference voltage set to pixels of even columns of the liquid crystal panel according to the polarity signal; when the polarity signal has the negative polarity, the source driving circuit generates and outputs the negative polarity Gamma reference voltage set to the pixels of the odd columns of the liquid crystal panel, and generates and outputs the positive polarity Gamma reference voltage set to the pixels of the even columns of the liquid crystal panel according to the polarity signal.

4. The method of claim 2, wherein when the polarity signal has the positive polarity, a source driving circuit generates and outputs the positive polarity Gamma reference voltage set to pixels of even columns of the liquid crystal panel, and generates and outputs the negative polarity Gamma reference voltage set to pixels of odd columns of the liquid crystal panel according to the polarity signal; when the polarity signal has the negative polarity, the source driving circuit generates and outputs the negative polarity Gamma reference voltage set to the pixels of the even columns of the liquid crystal panel, and generates and outputs the positive polarity Gamma reference voltage set to the pixels of the odd columns of the liquid crystal panel according to the polarity signal.

5. The method of claim 1, wherein when panel type is an organic light-emitting diode panel, the polarity signal is a positive polarity signal or a negative polarity signal.

6. The method of claim 5, wherein when the polarity signal is the positive polarity signal, the plurality of Gamma reference voltages include a positive polarity Gamma reference voltage set and a positive polarity Gamma reference voltages derived from a negative polarity Gamma reference voltage set, and a source driving circuit generates and outputs the positive polarity Gamma reference voltage set and the positive polarity Gamma reference voltages derived from the negative polarity Gamma reference voltage set to the organic light-emitting diode panel according to the positive polarity signal, wherein a voltage number of the positive polarity Gamma reference voltage set is the same as a voltage number of the negative polarity Gamma reference voltage set.

7. The method of claim 5, wherein when the polarity signal is the negative polarity signal, the plurality of Gamma reference voltages include a negative polarity Gamma reference voltage set and a negative polarity Gamma reference voltages derived from a positive polarity Gamma reference voltage set, and a source driving circuit generates and outputs the negative polarity Gamma reference voltage set and the negative polarity Gamma reference voltages derived from the positive polarity Gamma reference voltage set to the organic light-emitting diode panel according to the negative polarity signal, wherein a voltage number of the negative polarity Gamma reference voltage set is the same as a voltage number of the positive polarity Gamma reference voltage set.

8. A source driving circuit for adjustable outputting Gamma reference voltages, the source driving circuit comprising:
a positive polarity Gamma reference voltage generation circuit for generating and outputting a positive polarity Gamma reference voltage set;
a negative polarity Gamma reference voltage generation circuit for generating and outputting a negative polarity Gamma reference voltage set;
a first switch pair coupled to the positive polarity Gamma reference voltage generation circuit for outputting the positive polarity Gamma reference voltage set to a panel according to a polarity signal corresponding to one of plural predetermined display panel types; and
a second switch pair coupled to the negative polarity Gamma reference voltage generation circuit for outputting the negative polarity Gamma reference voltage set to the panel according to the polarity signal;
wherein a plurality of polarity control signals corresponding to the panel types of the plurality of display panels are different.

9. The source driving circuit of claim 8, further comprising:
an inverter for generating an inverse signal of the polarity signal.

10. The source driving circuit of claim 9, wherein
the first switch pair comprises:
a first switch having a first terminal coupled to the positive polarity Gamma reference voltage generation circuit, a second terminal for receiving the inverse signal of the polarity signal, and a third terminal for outputting the positive polarity Gamma reference voltage set to even column data lines of the panel; and
a second switch having a first terminal coupled to the positive polarity Gamma reference voltage generation circuit, a second terminal for receiving the polarity signal, and a third terminal for outputting the positive polarity Gamma reference voltage set to odd column data lines of the panel; and
the second switch pair comprises:
a third switch having a first terminal coupled to the negative polarity Gamma reference voltage generation circuit, a second terminal for receiving the inverse signal of the polarity signal, and a third terminal for outputting the negative polarity Gamma reference voltage set to the odd column data lines of the panel; and
a fourth switch having a first terminal coupled to the negative polarity Gamma reference voltage generation circuit, a second terminal for receiving the polarity signal, and a third terminal for outputting the positive polarity Gamma reference voltage set to the even column data lines of the panel.

11. The source driving circuit of claim 8, wherein the panel is a liquid crystal panel or an organic light-emitting diode panel.
